(19) United States
(12) Patent Application Publication
(10) Pub. No.: US 2008/0004740 A1
(43) Pub. Date: Jan. 3, 2008

(54) Providing status information for a material

(76) Inventors: Noam Tamarkin, Binyamina (IL); Roni Avni, Petah-Tikva (IL); Thomas Friedrich, Walldorf (DE); Shai Alfandary, Zur Moshe (IL)

Correspondence Address: FISH & RICHARDSON, P.C., PO BOX 1022, MINNEAPOLIS, MN, 55440-1022, US

(21) Appl. No.: 11/478,001

(22) Filed: Jun. 28, 2006

(51) Int. Cl. G06F 19/00

(52) U.S. Cl. 700/106; 700/107

(57) ABSTRACT

A computer-implemented method for providing status information for a material includes obtaining information at least in part from an electronic database order object that has been released from a planning process for execution. The order object defines a requirement for a material. Using the obtained information, status information for the material is determined for a location. A predefined output regarding the material is generated using the determined status information. A graphical user interface for providing status information for a material includes a first input control for user identification of the material, an area presenting information about a status of the material at a location, and a second input control for a user to initiate, after presentation of the information about the status of the material, an action to modify the status.

### TECHNICAL FIELD

This document relates to providing status information for a material that is subject to execution of an order.

### BACKGROUND

There exists systems for computerized automation of operations and processes in industrial or other commercial enterprises. Examples of such existing systems are those available from SAPAG in Walldorf (Baden) Germany. Some of the existing systems are intended for use with the logistic procedures and operations that are common in manufacturing processes and they are therefore typically used in production plants. Other systems, or components of systems, are intended for use in the logistic management of products that have already been manufactured. They are therefore typically used in warehouses, distribution centers and other facilities where goods may be inspected, repacked and moved to particular storage locations while awaiting shipment.

The distribution of responsibilities and functionality between these two categories of systems is based on the way that these industries have emerged and developed historically. That is, over decades in the past, production plants and similar facilities have carried out their operations according to well-established routines that involve the basic steps of making the product. Improvements in technology have changed the way certain tasks are performed, but the general logistic view of how the core constituents of the manufacturing process is carried out has not changed as significantly. Similarly, warehouses have traditionally been viewed as facilities mainly for logistic management of goods without significant modification and, thus, essentially non-manufacturing in nature.

This view is reflected in the existing systems for controlling manufacturing processes. The computer model they use for the different components of the process are typically specialized and heavily flavored by the traditional manufacturing view. Systems for warehouse management, in contrast, have other computer models that are targeted toward managing the logistics of storing and eventually delivering goods. A disadvantage of existing systems, then, is that they are designed and configured for only their type of process and lack flexibility in adapting to new demands in the industry and the marketplace that challenge the traditional views.

The above and other characteristics also affect the way reporting and alerting is done in computerized material-management systems. For example, existing systems may have features for reporting the status of a material that are focused on the planning stage of operations, not directly on the execution stage. Because execution is often specified in more detail than planning, and because execution sometimes diverges to some degree from what was planned, relying on information from the planning level may impact the quality of the forecasting or the alerting that can be accomplished. Such factors are often important drivers of the overall value of a computer system to its customer, and may therefore be relevant in a cost of ownership analysis.

### SUMMARY

The invention relates to status information for a material. For example, it is described that relevant information is obtained at least in part from an execution-level order object.

In a first general aspect, a computer-implemented method for providing status information for a material includes obtaining information at least in part from an electronic database order object that has been released from a planning process for execution. The order object defines a requirement for a material. Using the obtained information, status information for the material is determined for a location. A predefined output regarding the material is generated using the determined status information.

Implementations may include any or all of the following features. The order object may be one of: a production order object where the requirement is to produce a first quantity of the material to the location; a production order object where the requirement is to use a second quantity of the material from the location; a warehouse order object where the requirement is to move a third quantity of the material to the location; and a warehouse order object where the requirement is to move a fourth quantity of the material from the location. A portion of the information that is not obtained from the order object may be obtained from at least one of: an inventory record for the location; logistics layout information for the location; and batch information about the material. Material management may be organized in a hierarchy in which the location is subdivided in several sub-locations, and obtaining the information may involve information aggregation over the several sub-locations. The status information may specify an amount of the material that is available at the location at a future time. When several released order objects regarding the material are to be executed before the future time, all of the several released order objects may be used in obtaining the information. The status information may specify an amount of time before a supply of the material at the location is depleted absent replenishment. The predefined output may be generated to an entity that is registered as a subscriber to the status information. The predefined output may be generated in response to a request for the status information received from an entity. The predefined output may include an alert generated upon applying a predefined rule to the status information. The alert may indicate that an order regarding the material that is to be executed at the location is inconsistent with the status information, and the predefined output may provide user access for modifying the order. The predefined output may include automatically modifying an order regarding the material that is to be executed at the location, the order being inconsistent with the status information. The predefined output may include proposing a cross-docking operation involving the material. The status information (i) may indicate that execution of the order object is to produce a first quantity of the material, and (ii) may indicate that, after the first quantity is produced, a second quantity of the material is to be used in executing another order object from which part of the information was obtained, and the cross-docking operation may include obtaining the second quantity from the first quantity without entering the second quantity into stock inventory.

In a second general aspect, a computer program product is tangibly embodied in an information carrier and includes instructions that, when executed, generate on a display device a graphical user interface for providing status information for a material. The graphical user interface includes a first input control for user identification of a material to cause information to be obtained from at least one electronic database order object that has been released from a planning process for execution, the order object defining a requirement for the material. The graphical user interface includes an area presenting information about a status of the material at a location, the information about the status determined using the obtained information. The graphical user interface includes a second input control for a user to initiate, after presentation of the information about the status of the material, an action to modify the status.

Implementations may include any or all of the following features. The information about the status of the material may specify at least one of an amount of the material that is available at the location at a future time; and an amount of time before a supply of the material at the location is depleted absent replenishment. The action that can be initiated may be a replenishment operation to supply an amount of the material. The action that can be initiated may be a cross-docking operation involving the material. The action that can be initiated may be a modification of an order regarding the material that is to be executed at the location.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 schematically shows an example of a model including an execution material flow view object.

FIG. 2A shows a diagram of an exemplary physical process including make, move and check operations.

FIG. 2B shows a hierarchical chart of a technical representation of the exemplary physical process shown in FIG. 2A.

FIG. 3 shows an example of physical and logical storage hierarchies.

FIG. 4 shows obtained information schematically illustrated in a timeline frame.

FIG. 5 shows an example of a graphical user interface that can be generated using the execution material flow view object of FIG. 1.

FIG. 6 shows another example of a graphical user interface that can be generated using the execution material flow view object of FIG. 1.

FIG. 7 is a block diagram of a computing system that can be used in connection with computer-implemented methods described in this document.

Like reference symbols in the various drawings indicate like elements.

### DETAILED DESCRIPTION

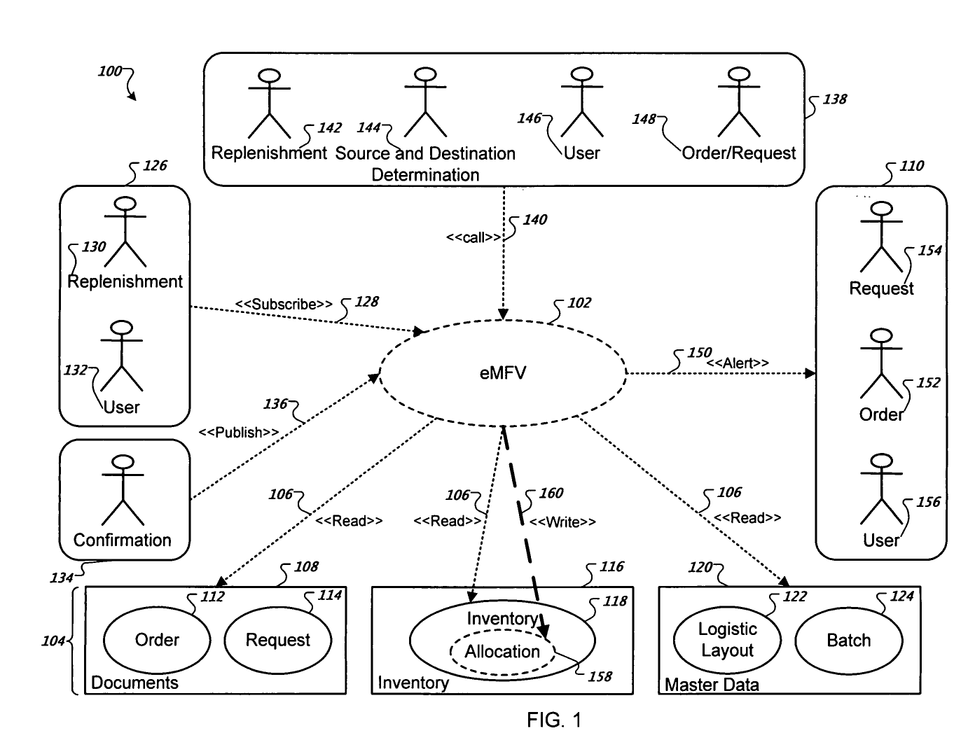

FIG. 1 schematically shows an example of a model 100 where an object 102 can be used to provide execution-level information on material flow. The object 102 in this example is configured to be used in generating a view of the obtained material flow information, and is therefore identified as execution-level Material Flow View (eMFV). The object 102 can support availability requests based on executable order objects, inventory information and master data, to name a few examples. Particularly, using the object 102 information can be obtained, at least in part, from an order object that defines a requirement for a material. Status information for the material for a specific location, such as the availability in a given bin, can be determined using the obtained information. Also, the determined status information can be used in generating a predefined output regarding the material, such as an availability view to be presented on a computer screen.

The object 102 obtains information from one or more information sources 104, as indicated by read arrows 106. The information sources in this example include execution-level documents 108, which are objects that result from a planning process 110. Particularly, the planning process lets a user plan various aspects of the actions that are to be performed, for example at a higher level of detail than that necessary for the actual execution of that action. When, in turn, the document 108 is released from the planning process, the necessary details may be added in a scheduling step, so as to form an order object 112 or a request object 114, for example. The order object represents an executable instruction to carry out one or more particular physical operations, such as a manufacturing step or the relocation of a product. The request object 114 contains information about physical operations that should be performed in a production line or a warehouse, to name two examples. In this implementation, the request object does not contain any information defining how to execute the operations; rather, the order object 112 takes information from the request object and uses it in describing the planned execution.

These execution objects may reflect operations to be performed in the future that affect the existence or availability of one or more specific materials. As such, the object 102 can obtain information from them to be taken into account in determining status information for the material, for example whether a certain units of a specific product will be available at a particular date. The objects 112 and 114 may be implemented using different computer-based techniques, such as in form of electronic objects compatible with a database.

The creation of the objects 112 or 114 signifies that the proceeding in this regard has reached an execution level in the management hierarchy. This, in turn, brings a certain level of finality to the steps to be executed. In normal circumstances, the specified actions are now expected to be carried out as defined the order object 112, unless the order is canceled or modified at the execution level. By contrast, a request or an order that exists in the planning process 110 may still be subject to significant modifications before it is released, if it ever is. As such, there is a lesser degree of certainty or finality to the objects in the planning process 110. Moreover, these objects may have a lower level of detail than the execution-level objects.

Another example of the information sources 104 is an inventory management module 116. Here, this module maintains a inventory record 118 that reflects the current inventory levels for one or more materials, such as products in a warehouse. The object 102 can obtain information from the inventory record 118, for example to determine how much of a material is currently in inventory.

Another example of the information sources 104 involves data specific to the implementation of the material flow system and is here denoted master data 120. For example, the master data 120 may include logistic layout data 122 that defines the logistical layout of the material flow system, for example how a production facility or a warehouse is organized. As another example, the master data may include batch information 124 that identifies specific batches of the one or more materials whose flow may be monitored. For example, the batch information may track a batch number of a material as that material is used in a production process. The object 102 can obtain the logistic layout information 122 for use in determining the availability of material at a specific storage location, or the batch information 124 to determine the availability of a particular material batch, to name two examples. Other information sources than those described here may be used.

The information obtained by the object 102 can be processed, provided to other recipients, or displayed, to name some examples. First, the model 100 here includes at least one subscriber 126 that can receive information from the object 102 as indicated by a subscription arrow 128. For example, a replenishment module 130 that is configured for use in administrating the replenishment of material to a storage location can be registered as a subscriber of information from the object 102 regarding a particular material. As another example, a user 132 who is a manager of the warehouse facility may be interested in subscribing to information regarding the status of one or more particular materials. The object 102 may send information to one or more of the subscribers when the relevant information becomes available, at predefined times, or according to another rule, to name some examples.

Second, the model 100 may include a confirmation module 134 that provides information to the object 102. For example, the confirmation module can be configured to publish or broadcast an announcement that a particular stock operation (e.g., manufacturing or transfer) has been completed. As such, the confirmation module can provide the object 102, as indicated by a publishing arrow 136, with information regarding the status of a particular material.

Third, one or more information consumers 138 in the system can trigger the object 102 to provide information for one or more objects. This may be done in form of a call to the object, as indicated by a call arrow 140. For example, a replenishment module 142 may request the object 102 to provide information that relates to the available quantity of a material, to aid the module 142 in determining whether to initiate replenishment. In contrast with the subscriber 126, which could include the replenishment module 130, the one or more information consumers 138 actively request the information. Moreover, the information consumers may generate these requests based on their schedule. A source and destination module 144 may request information from the object 102 to help determine the source of a particular material, or its destination. A user 146 may call up the object 102 to obtain material flow information of interest to the user. An order/request module 148 may obtain material flow information from the object 102 to aid in the creation or maintenance of orders or requests.

In some implementations, the object 102 can apply one or more rules to the information obtained from the information sources 104. One example is the generation of an alert, as indicated by an alert arrow 150. An alert may be generated upon a determination that the obtained information meets at least one predefined criterion regarding the material. For example, criteria may include that the level of material in stock is too low or too high. A generated alert may be forwarded to any recipient, such as entities in the planning process 110. Here, an order object 152 is an entity, e.g., a document, and it is used for planning, such as scheduling of machines and other resources. The order object 152 may receive the alert and, in response thereto, may trigger a planning adjustment. Such an adjustment may be done to manufacture more, or less, of the product, as an example. A request object 154 is responsible for higher-level planning in the process 110 and may similarly receive the alert and optionally act upon it as appropriate. A user 156 who is a warehouse manager may receive notification that there is a situation in the warehouse that involves an abnormal material flow condition. Other alert recipients may be used.

The object 102 may also be involved in maintaining allocations in the model. For example, the inventory record 118 may include an allocation record 158 that tracks any or all inventory materials that have been allocated for use in an order. For example, the allocation record can indicate that of 50 units of stock on hand, ten have been allocated. The object 102 can read this information (read arrow 106), or update it, as indicated by a write arrow 160, to name some examples.

Each forwarding of information described above may be carried out using any suitable technology for information transfer, including function calls, asynchronous communication, electronic data transfer, or a markup-language based knowledge transmission, to name a few examples.

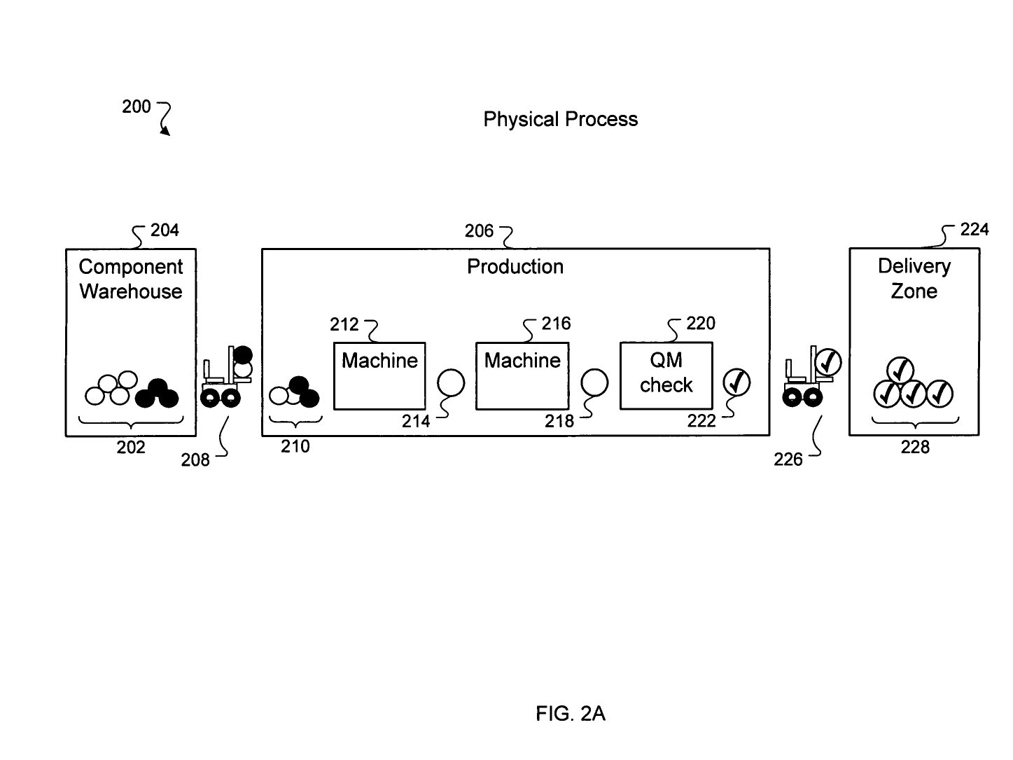

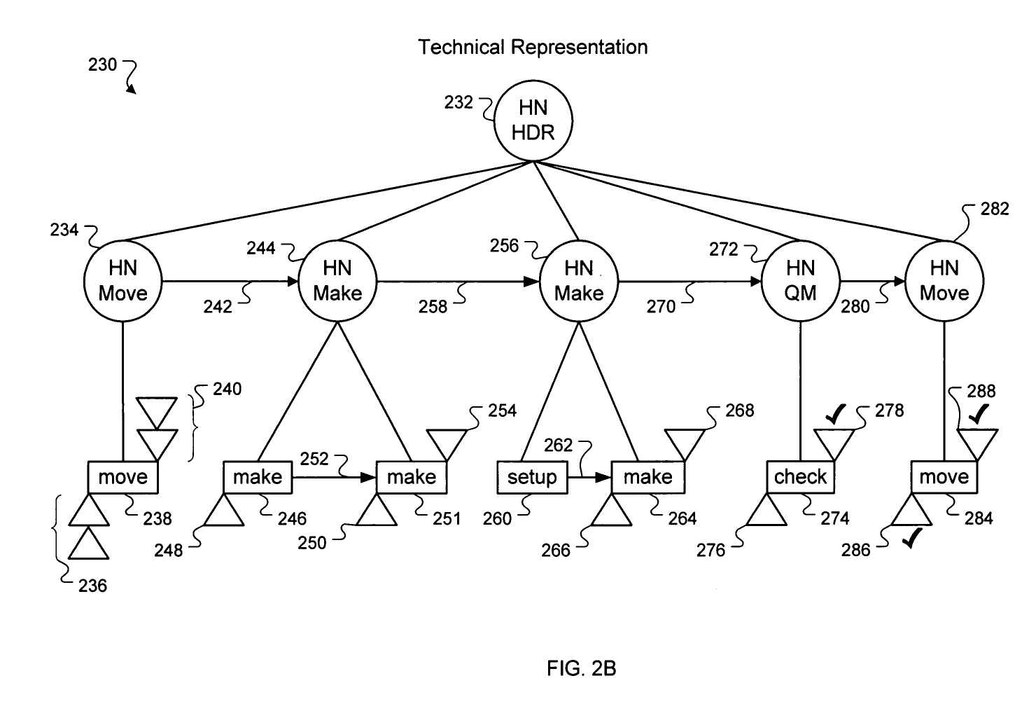

In the above description, some features have been exemplified as relating to a production facility, a warehouse, or both. With reference now to FIGS. 2A and 2B, there will be described an example of how a computer system can plan and execute both production-type operations and warehouse-type operations. FIG. 2A shows a physical process 200 performed for an exemplary product order. FIG. 2B shows a technical representation 230 of the physical process of FIG. 2A that uses execution objects in performing the operations. Particularly, an operation that is part of producing a material may be requested by a production request object and executed using a production order object. Similarly, an operation that is part of moving a material may be requested by a warehouse request object and executed using a warehouse order object. Either or both of such a production request object or a warehouse request object can form the request object 114 in the information sources 104, to name some examples. Similarly, either or both of such a production order object and a warehouse order object can form the order object 112, to name some examples.

The physical process 200 uses at least two different raw materials 202 stored in a component warehouse 204. These raw materials 202 are to be used in the manufacturing of a product in a production facility 206. The raw materials 202 are physically moved from the component warehouse 204 to the production location 206 using a resource 208, for example a forklift. The raw materials 202 are placed at a raw materials receiving area 210. From the raw materials receiving area 210 the raw materials are provided to a machine 212 used in the manufacture of the product. The machine 212 produces an intermediate product 214 using the raw materials 202. The intermediate product 214 is used by a machine 216 that, in this example, produces a finished product 218. The finished product 218 is then put through a Quality Management (QM) check 220. If the finished product 218 fails the QM check 220 it can be discarded at this point or be sent back for additional processing. If the finished product 218 passes the QM check 220, it is then considered an approved product 222. The approved product 222 is then physically moved to a delivery zone 224 using a resource 226, for example, a forklift. This move may be between areas within a physical plant or between separate plants. The approved product 222 is placed in a final product receiving area 228 where it may be placed in inventory for later shipment to a customer.

In FIG. 2B, the technical representation 230 uses hierarchical nodes (HN) as generic structuring elements within a framework. The framework consists of a building of hierarchy nodes that may have one or more activity objects associated with them. Particularly, the hierarchical nodes can be used with both production-type operations and warehouse-type operations. A hierarchy node header (HN HDR) 232 represents the product order.

A HN Move node 234 represents the moving of the raw materials 202 from the component warehouse 204 to the production facility 206. An activity 238 is associated with the HN Move node 234. The activity 238 takes inputs 236, which are the two different raw materials 202, and performs a move operation. This results in outputs 240, which correspond to the two different raw materials 202 being placed into the raw material receiving area 210. The move operation uses the resource 208, which in the example is a forklift. A network 242 connects the HN Move node 234 to a HN make node 244, which is the next execution node in the order process.

The HN Make node 244 represents the operation of the machine 212. The node has two activity nodes associated with it. An activity 246 performs a make operation using an input 248. The activity 246 corresponds to a first portion of the operation performed by the machine 212. For example, the activity 246 is performed on the white material of the raw materials 202. After the activity 246 there follows an input 250 into an activity 251 which corresponds to a second portion of the operation performed by the machine 212. For example, the activity 251 involves adding the black material of the raw materials 202 to the processed white material. An activity relation 252 indicates that the activity 246 is performed before the activity 251. The activity 251 performs a make operation using the input 250 to produce an output 254, which represents the intermediate product 214. An HN Make node 256 represents the operation performed by the machine 216. The HN make node 256 and the HN Make node 244 together represent the physical manufacturing process for the product as shown by the network 258.

The HN Make node 256 has associated with it two activity objects. An activity 260 is a setup operation, for example to set up the machine 216. An activity relation 262 indicates that the activity 260 is performed before an activity 264. The activity 264 is a make operation using input 266, which is the intermediate product 214 and resulting in output 268, which is the finished product 218. A network 270 shows that a HN QM node 272 is the next execution node in the order process.

The HN QM node 272 represents the QM check 220 of the physical process. The node has associated with it an activity 274 to perform a check operation on an input 276, which is the finished product 218, and to produce an output 278, which is the approved product 222. A network 280 shows that a HN Move node 282 is the next execution node in the order process.

The HN Move node 282 represents the movement of the approved product 222 from the production location 206 to the delivery zone 224. The node has associated with it an activity 284 to place the approved product 222 in a specific location. It does this by performing a move operation using a resource 226. An input 286 is the approved product 222 in the production location 206 and an output 288 is the approved product in the delivery zone 224.

Accordingly, the structures shown in FIGS. 2A-2B are examples of those that can be used in planning and executing a particular order. With reference again to FIG. 1, the object 102, which can be responsible for generating a view of the execution-level material flow, can obtain information at least in part from the objects that are to be used in the execution of the planned operation(s). The information relates to a material, such as any or all of the raw material 202, the intermediate product 214 and the finished product 218 in the above example. Status information for the relevant material, such as its availability, is determined using the obtained information. Also, the object 102 generates a predefined output regarding the material using the determined status information, such as by publishing the information or generating an alert.

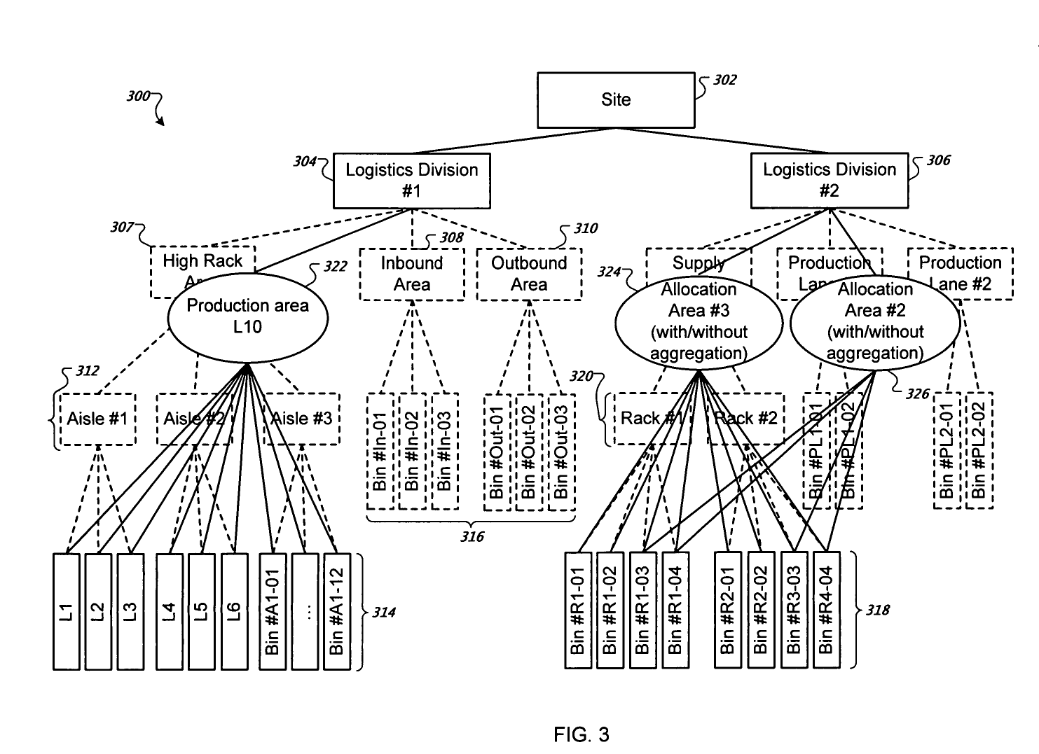

The status information for the material is determined for a particular location. This may be a physical location or a logical location. For example, FIG. 3 shows a warehouse organization 300 that describes how a particular warehouse is arranged. Here, logical locations are shown with solid outline and physical locations are marked with a dashed outline. So, for example, is the warehouse as a whole denoted site 302, and this facility is divided into a first division 304 and a second division 306. Here, the site 302 and the first and second divisions 304-306 are both physical and logical locations, and are shown with solid outlines for clarity.

Each physical location may be subdivided in one or more smaller areas. The first division 304 includes a high-rack area 307, an inbound area 308 and an outbound area 310. The high-rack area may correspond to a storage location where individual shelves or racks are reachable by forklift. The inbound area, in turn, is an area where incoming material is received in the warehouse. Similarly, the outbound area is an area from which materials are sent out of the warehouse. The high-rack area 306, in turn, is divided into three aisles 312, each of which can include one or more bins 314. Similarly, each of the inbound area 308 and the outbound area 310 is subdivided into one or more bins 316.

Looking now at the second division 306, it is subdivided into three areas that, in turn, can be subdivided into one or more bins 318. As with the first division, there may be additional intermediate levels 320 of organization such as a rack level for several bins.

Material can be physically located in any of the physical storage locations of the organization 300. For example, material may be located in a bin, in an aisle, in a high-rack area, in one of the divisions or in the warehouse as a whole.

A logical organization (solid lines) is now implemented in the warehouse. In some regards, the logical organization conforms with the physical one, for example in the site 302 and the divisions 304 and 306. In other regards, however, the logical organization somewhat differs from the physical one. Relating to the first division 304, for example, there is created a logical production area 322 that includes the bins 314 but not the aisles 312. This means that the production area 322 is considered to include the contents of the bins 312 but not the contents of the aisles 312 that is not confined to any of the bins. Similarly, the second division 306 can be provided with allocation areas 324 and 326 that encompass the bins 318 but not any of the intermediary storage locations 320 such as the racks.

Because the object 102 obtains information from one or more execution-level order objects, and because it is defined as a central broker of information relating to material flow, it can be very useful in combination with management of material in an organization that mixes physical and logical hierarchies. For example, information at different levels of the organization 300 can be aggregated in determining material flow.

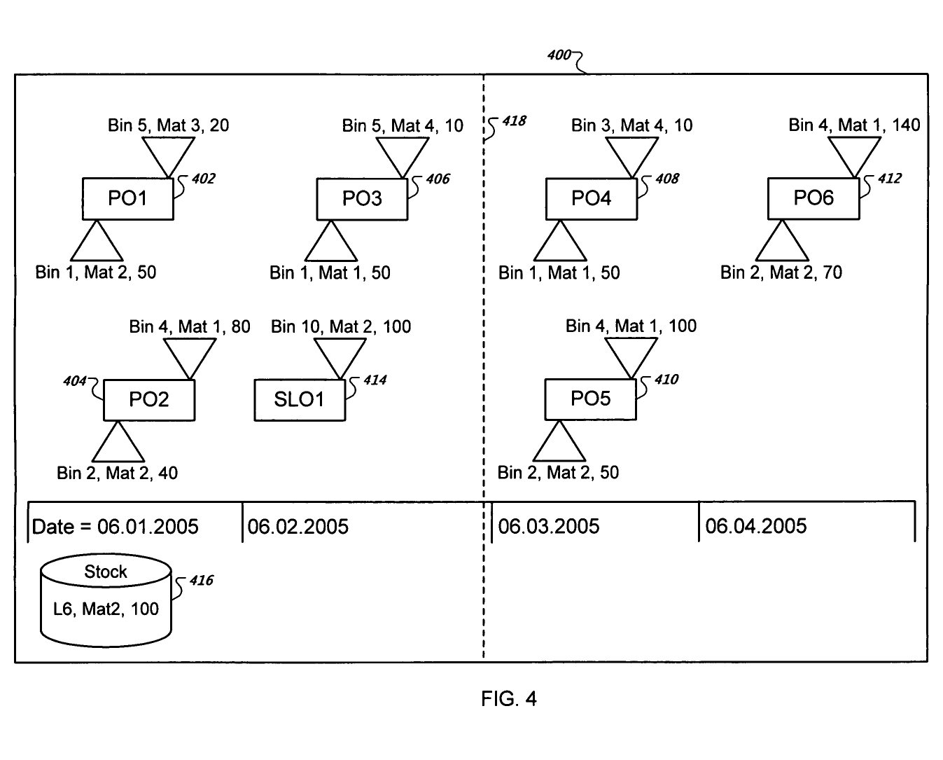

There will now be described with reference to FIG. 4 an example of determining status information using information obtained from one or more objects. Particularly, there is schematically shown a timeline frame 400 that includes some material operations that are to be performed in a given time frame. That time frame may be defined for the time interval that is of interest, whether it relate to a time of a few seconds, minutes, hours, days, weeks, months, years or some other time measure. Here, the time frame is four calendar days: Jun. 1-4, 2005.

One or more operations may be scheduled to take place each day (or other relevant time interval). Here, the orders that represent the operations are schematically illustrated as rectangles bearing a label “PO” for production order or “SLO” for site logistics order, where site logistics is a synonym for warehouse operations. Each rectangle may be provided with either or both of: an upward pointing triangle to illustrate an input that is required for the operation, and a downward pointing triangle to illustrate an output that is required from the operation. The triangles are here labeled with the specific information regarding the corresponding input or output. For example, a first production order 402 is scheduled to be executed on Jun. 1, 2005. It requires an input of 50 units of Material 2 (Mat 2) that is to be obtained from Bin 1. The first production order results in 20 units of Material 3 being delivered to Bin 5. Thus, the first production order takes 50 units of a first material from one location and uses them in manufacturing 50 units of another material (such as a product) that is delivered to another location. There are five other production orders 404, 406, 408, 410 and 412 distributed over the days of the timeline, and each of them have corresponding labels and indicia.

A site logistics order 414 is scheduled to be performed on Jun. 2, 2005 to deliver 100 units of Material 2 at Bin 10. The order 414 does not have an input specified in this illustration. This is because the input is provided from a storage area or other location that is not covered by the current flow management system. As such, the information regarding where the input for the site logistics operation is obtained does not affect any inventory data or other information in this system.

Inventory may be tracked using a stock repository 416. Currently, the stock repository indicates that there are 100 units of Material 2 in stock at location L6 (which may be one of the bins 314, see FIG. 3). Thus, the timeline frame 400 schematically illustrates information that is available, for example in the information sources 104 (FIG. 1) for material-flow analysis.

One example of an analysis that can be performed is to determine what stock is available on a certain date (sometimes referred to as projected inventory). Assume, in this example, that a user wishes to know how many units of Material 2 will be available at the end of Jun. 2, 2005. This date of interest (arbitrarily chosen here) is schematically illustrated by an availability marker 418. The location that this inquiry relates to is not merely a single bin, but rather includes several bins in the facility. For example, assume that the specified location is the production area 322 (FIG. 4), which includes the several bins 314.

To determine the status of the Material 2 for this location at the specified date, it may first be determined how much of the material is currently in stock. From the stock repository 416 it is determined that 100 units of this material is in stock. Next, it may be determined that the production order 402 to be executed between now and the date of interest will consume 50 units of the material. Similarly, the production order 404 is planned to consume 40 units of the material, albeit from a different location than the other order, when executed. Accordingly, the allocation of certain quantities of Material 2 for these two operations diminishes the amount that will be available. Finally, it may be determined that the site logistics operation 414 will result in 100 units of the material being made available in the Bin 10. Thus, the calculation of availability for this specific date comes down to:
100−40−50+100=110

In other words, it is determined, using the information schematically illustrated in the timeline frame 400, that 110 units of the Material 2 will be available in the production area 322 at the end of Jun. 2, 2005. This example also shows that information is aggregated from different storage locations, or in other words from different locations in a hierarchy. For example, the material quantities in the calculation above relate to the orders 402, 404 and 414. The two former are production orders that take their required materials from Bins 1 and 2 in this example. The latter one, in contrast, is a site logistics order that delivers the material to Bin 10. As indicated in FIG. 3 above, bins are included at one or more levels of a hierarchy. Accordingly, the above calculation involves aggregation of information from different hierarchy locations.

As a second example of analysis that can be performed, the information in the timeline frame 400 can be used to calculate a “days of supply” measure for a specified material. Assume, for example, that the user wants to know how long the current inventory will last without replenishments, taking into account planned and scheduled order requirements. The user would then specify, for example, the location of interest and the product at issue. A result is then determined using the information about the scheduled orders. For example, the result may be calculated using average demands for a specified forecast horizon, such as a number of hours or days. This takes into account the demands (e.g., production orders that have requirements that the material be consumed) that are currently scheduled for the timeframe of the forecast horizon and defines a measure of average demand per day. Then, the scheduled supplies (e.g., site logistics orders that have requirements that material be moved to the location) are divided by the average demand per day to obtain an estimate of the number of days before the current supply runs out. Other approaches for calculating the days of supply may be used.

A third example of analysis that can be performed using the information in the timeline frame 400 is a dynamic pegging determination. This is sometimes referred to as a “cross-docking” operation because, by analogy, it is similar to the approach of moving incoming goods across the dock when they arrive to fill an order of outgoing goods. Here, the system can analyze the currently scheduled orders to find out whether there are any opportunities for dynamically linking the output from one order to the input of another. In other words, making the material flow more effective. For example, assume that it is determined that the production order 404 generates 80 units of the Material 1 and that the production order 406 requires 50 units of the same material as input. If dynamic pegging is not done in this example, the 80 units produced by order 404 will be delivered to Bin 4 as planned, will be entered into stock inventory, and will thereafter remain available for use in accordance with the planning. Similarly, the production order 406 will then obtain its required 50 units of the material from the Bin 1 and use them in the operation. Those required 50 units will likely exist in stock inventory when they are taken from the Bin 1 and the inventory record for these units should be updated upon them being used in the production.

In contrast, dynamic pegging can eliminate the need to enter some materials into stock inventory. In this implementation, the dynamic pegging is a proposal that may be presented in a GUI. Upon seeing the proposal, a user (e.g., a manager of the facility) can accept or reject it, for example using an input control of the GUI. In other implementations, the dynamic pegging may be performed automatically.

If performed, the dynamic pegging means that a portion of the materials produced by order 404 need not be entered into stock inventory. For example, some of the units produced by the order 404 can be reserved (“pegged”) for the order 406. Rather, only 30 of the 80 units that the order 404 produces may need to be entered into stock inventory, unless another opportunity for dynamic pegging can be identified. In this example, there is another opportunity. For example, the production order 408 is scheduled to require 50 units of the Material 1 when it is executed. A dynamic pegging may then be proposed, so that the 30 units from order 404 that were not previously allocated, are instead dynamically pegged for the order 408. If the dynamic pegging is done, this means that none of the 80 units produced by the order 404 need be entered into stock inventory. The order 408, in turn will get 30 of its required 50 units from the order 404 and the remainder from elsewhere (e.g., from stock inventory). Another opportunity for dynamic pegging that may be identified is that the production order 410 can obtain its entire input requirement (50 units of Material 2) from the output of the site logistics order 414.

The proposal for dynamic pegging may comprise the following information presented in a GUI:

TABLE 1

| Doc. Date From | Doc. ID From | Doc. Date To | Doc. ID To | Product | Possible Qty |
|---|---|---|---|---|---|
| 06.01.2005, 09:00 | PO2 O-node | 06.02.2005, 14:00 | PO3 I-node | Mat1 | 50 |
| 06.01.2005, 09:00 | PO2 O-node | 06.03.2005, 10:00 | PO4 I-node | Mat1 | 30 |
| 06.01.2005, 10:50 | SLO1 O-node | 06.03.2005, 10:50 | PO4 I-node | Mat2 | 50 |

As illustrated in Table 1, the three proposed dynamic peggings described above are listed with their related information. The first row proposes a pegging from June 1 at 9.00 am in the timeline frame to 2 pm on June 2. Particularly, the pegging is done from “PO2 O-node”, which means the output node of the production order 404 (labeled PO2 in the drawing), to “PO3 I-node”, which is the input node of the order 406. The Table indicates that this pegging relates to 50 units of the Material 1. Similarly, the second row proposes that 30 units of the Material 1 from the output node of the order 404 be used for the input node of the production order 408. Finally, the last row proposes that 50 units of the Material 2 from the output of the site logistics order 414 can be used as an input for the production order 410.

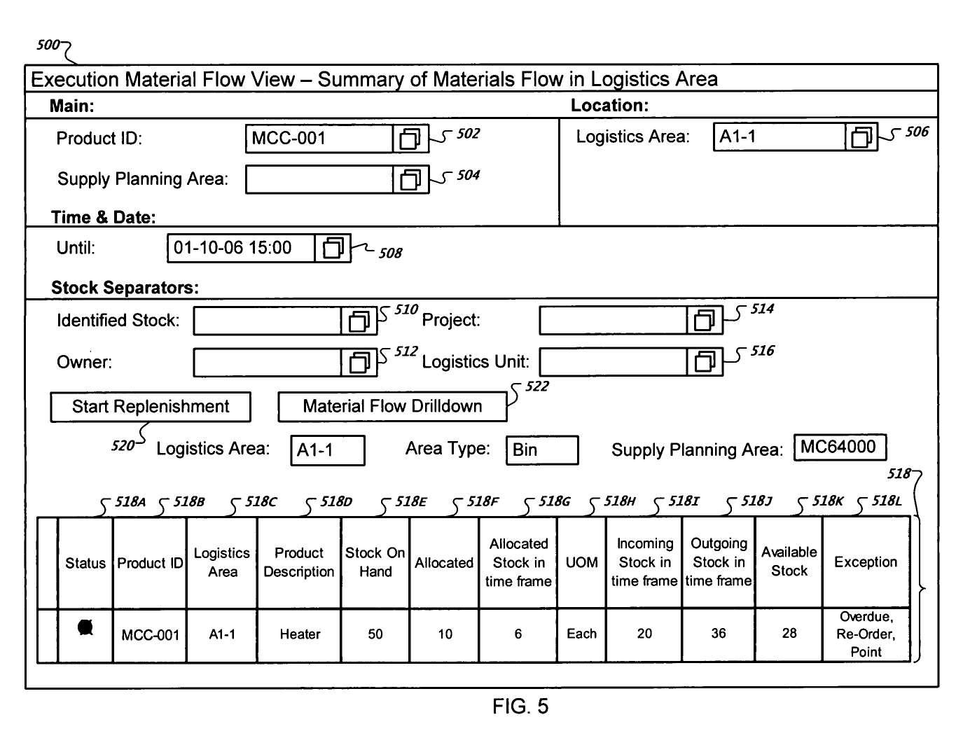

The information determined in any or all analyses can be presented in a predefined output as will now be exemplified with reference to FIG. 5. There is shown a graphical user interface (GUI) 500 that can be generated using the object 102 (FIG. 1) and presented on a display device. A user can then consult the GUI to make an availability determination, to name one example.

The GUI includes a first input control 502 for a user to identify one or more products of interest. Here, a product MCC-001 has been entered. A second input control 504 allows user specification of the area for the supply planning: for example that stock is to be used for production and that supply is to be used for repair. A third input control 506 allows the user to restrict the availability inquiry to one or more specific logistics areas (here, the entry A1-1 has been made).

Another few input controls in the GUI 500 allow further specifications. A time entry control 508 specifies the time (interval) of interest. Here, the time frame is defined as starting at the present time and ending at the specified time. In some implementations, the control 508 can have a FROM/TO configuration to aid an analysis of material flow throughout the specified time period. A control 510 allows the user to restrict the inquiry to a particular batch of the material. Control 512 limits the inquiry to a particular owner of the stock. Control 514 allows the user to specify that the sought availability is for a specific project. A control 516 is for specifying a logistics unit for the material whose availability is sought, such as a case, pallet or other container.

With the exemplary information entered as shown, the GUI can update a presentation are 518 with status information determined for the material and the specified logistics area. Particularly, the area 518 here presents status information and other data in the following fields:

Field 518A contains a status indicator to be described below;

Field 518B identifies the product at issue;

Field 518C identifies the logistics area to which the inquiry relates;

Field 518D contains a product description;

Field 518E specifies that 50 units of the material is on hand (e.g., in inventory);

Field 518F specifies that a total of 10 units of the material have been allocated (e.g., into a production order that is to be executed);

Field 518G specifies that 6 units of the material have been allocated within the relevant time frame (i.e., specified in control 508);

Field 518H specifies that a unit of measurement (UOM) is “Each”, meaning that each unit is counted as one;

Field 5181 specifies that 20 incoming units of the material are expected in the time frame (e.g., through a site logistics order);

Field 518J specifies that 36 units of the material are expected to go out in the time frame (e.g., by being shipped to customer);

Field 518K specifies that 28 units of the material are available at the specified date (i.e., 50−6+20−36=28); and

Field 518L specifies whether the obtained data gives rise to one or more exceptions or other predefined situation (for example, time to reorder).

Thus, the presentation area 518 gives the user an overview of the material flow for the specified material and can, for example, answer the question of availability for a particular time. The user can initiate one or more actions to modify the status of the material. The GUI here includes a “Start Replenishment” input control 520 that can be used to initiate a replenishment of the specified material (here: MCC-001).

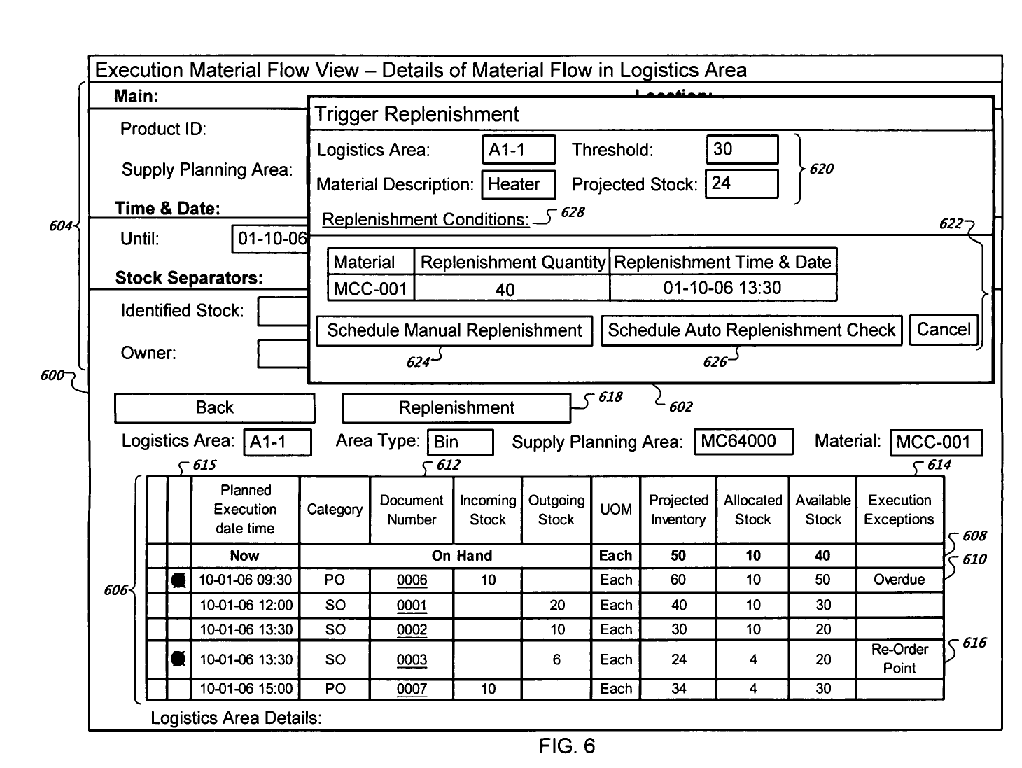

The GUI can provide more detailed information about the material flow. In this example, the GUI 500 includes a “Material Flow Drilldown” input control 522 that can be used to trigger a display of further details. If the user activates the control 522, a screen as illustrated in FIG. 6 may be presented, where a GUI 600 contains additional information about the material flow. In this figure, a popup window 602 that will be described below is temporarily presented on top of the GUI 600.

The GUI 600 includes an information specification area 604 that may be essentially equivalent to that of the GUI 500 (FIG. 5). Below that, an order presentation area 606 now specifies details about the current status. First, a “Now” row 608 indicates the situation at the present time (i.e., when the information for the GUI 600 was retrieved for display). The Now row shows that the projected inventory of the material at issue is 50 units, and that 10 of these have been allocated (e.g., reserved for use in executing an order). This leaves 40 units as available stock, as the Now row indicates.

Next, the area 606 shows details about the one or more orders that are scheduled to be executed in the time frame that the inquiry covers. For example, a first order 610 is scheduled for execution on Oct. 1, 2006, at 9:30 am. This is a production order (PO) and its number (0006) is indicated in a column 612. Moreover, the entries in the column 612 may be links to the actual corresponding order, e.g., a structure defined by the underlying order object 112 (FIG. 1). This allows a user to navigate from the GUI 600 directly to any or all of the orders that are listed there. Upon following the link, the user can modify the order at issue, and thereby modify the status of the material. In other implementations, another type of input control can be used for viewing or modifying the order. For example, the order information may be modifiable in the GUI 600.

An “Execution Exceptions” column 614 indicates any exceptions associated with each order. For several of the orders currently listed in the area 606 this column is empty, but for the order 610 the column states “Overdue”. This is because the order 610 should have begun executing some time ago. Thus, the column 614 indicates that there may be a problem with this order. However, the problem does not appear to be caused by a shortage of the material MCC-001; the order 610 does not require it as an input.

The GUI 600 may contain one or more alert indications. The entries in the column 614 have been mentioned as an example. Another example is that a flag can automatically be placed in an alert column 615. Here, such a flag has been generated for the order 610 to indicate its overdue status. A user can navigate to the order whose flag has been raised and attempt to change its status, for example to trigger its execution or to modify the order in another way. Other forms of alerts can be used.

Another entry that is currently flagged is an order 616 that is scheduled for execution on Oct. 1, 2006, at 1:30 pm. This is a site logistics order (SO) that will move six units of the material from the specified logistics area (A1-1). These six units are part of the ten units of allocated stock, and upon execution the projected inventory will stand at 24 units. In this implementation, that number triggers a reorder instruction that generates the “Re-Order Point” entry to appear in the column 614.

A user need not, however, wait until the execution of the order 616 to reorder or replenish. A “Replenishment” input control 618 in the GUI 600 lets the user initiate a replenishment of the material at any time. Thus, the popup may not be present when the GUI 600 is first generated, but may appear when the control 618 is activated.

The popup window 602 includes an information specification area 620 that indicates the logistics area, the material description, the threshold for the reorder point, and the current amount of projected stock. In a replenishment specification area 622 the user can view or edit details of the replenishment. Such details include the type of material, the replenishment quantity and the time and date for the replenishment. A control 624 allows the user to schedule a manual replenishment using the information entered in the popup 602. A control 626 allows the user to schedule an automatic replenishment check for a specified time or times. A “Replenishment Conditions” control 628 allows the user to view or modify conditions of the replenishment. An example of a replenishment condition is the material quantity threshold for triggering replenishment. Thus, the control 628 provides access to the information on which the user can base the decision to trigger replenishment. Such information can be used in automatically triggering replenishment, to name another example.

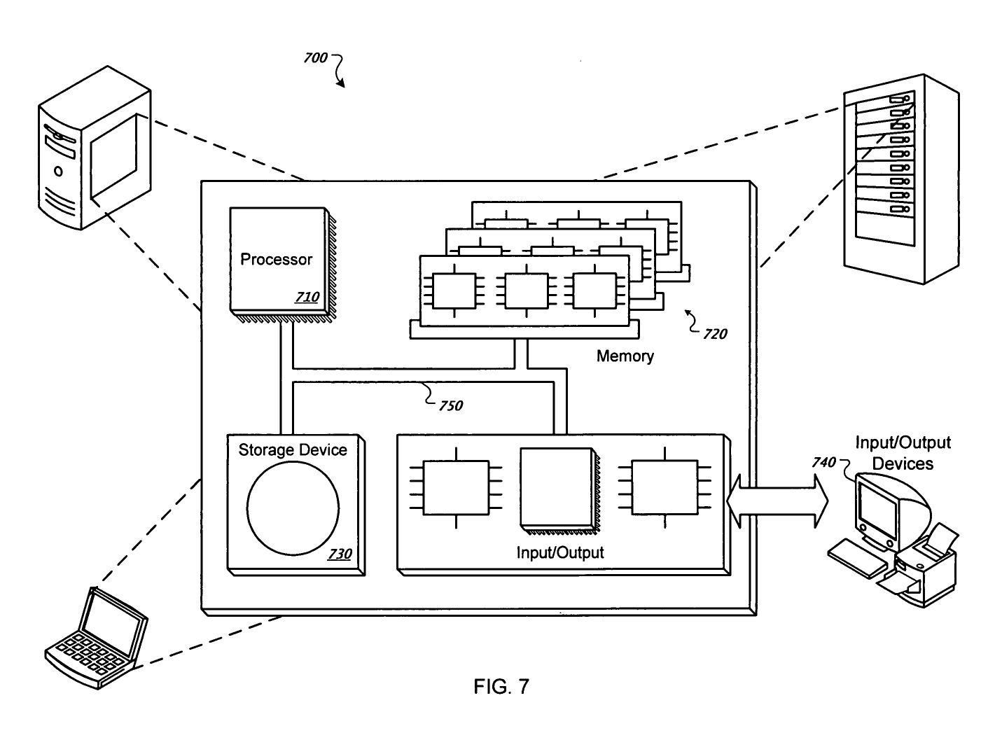

FIG. 7 is a schematic diagram of a generic computer system 700. The system 700 can be used for the operations described in association with any of the computer-implement methods described previously, according to one implementation. The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 may be a floppy disk device, a hard disk device, an optical disk device, or a tape device.

The input/output device 740 provides input/output operations for the system 700. In one implementation, the input/output device 740 includes a keyboard and/or pointing device. In another implementation, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A computer-implemented method for providing status information for a material, the computer-implemented method comprising:
obtaining information at least in part from an electronic database order object that has been released from a planning process for execution, the order object defining a requirement for a material;
determining, using the obtained information, status information for the material for a location; and
generating a predefined output regarding the material using the determined status information.

2. The computer-implemented method of claim 1, wherein the order object is at least one of:
a production order object where the requirement is to produce a first quantity of the material to the location;
a production order object where the requirement is to use a second quantity of the material from the location;
a warehouse order object where the requirement is to move a third quantity of the material to the location; and
a warehouse order object where the requirement is to move a fourth quantity of the material from the location.

3. The computer-implemented method of claim 1, wherein a portion of the information that is not obtained from the order object is obtained from at least one of:
an inventory record for the location;
logistics layout information for the location; and
hatch information about the material.

4. The computer-implemented method of claim 1, wherein material management is organized in a hierarchy in which the location is subdivided in several sub-locations, and wherein obtaining the information involves information aggregation over the several sub-locations.

5. The computer-implemented method of claim 1, wherein the status information specifies an amount of the material that is available at the location at a future time.

6. The computer-implemented method of claim 5, wherein several released order objects regarding the material are to be executed before the future time, and wherein all of the several released order objects are used in obtaining the information.

7. The computer-implemented method of claim 1, wherein the status information specifies an amount of time before a supply of the material at the location is depleted absent replenishment.

8. The computer-implemented method of claim 1, wherein the predefined output is generated to an entity that is registered as a subscriber to the status information.

9. The computer-implemented method of claim 1, wherein the predefined output is generated in response to a request for the status information received from an entity.

10. The computer-implemented method of claim 1, wherein the predefined output includes an alert generated upon applying a predefined rule to the status information.

11. The computer-implemented method of claim 10, wherein the alert indicates that an order regarding the material that is to be executed at the location is inconsistent with the status information, and wherein the predefined output provides user access for modifying the order.

12. The computer-implemented method of claim 1, wherein the predefined output comprises automatically modifying an order regarding the material that is to be executed at the location, the order being inconsistent with the status information.

13. The computer-implemented method of claim 1, wherein the predefined output comprises proposing a cross-docking operation involving the material.

14. The computer-implemented method of claim 13, wherein the status information (i) indicates that execution of the order object is to produce a first quantity of the material, and (ii) indicates that, after the first quantity is produced, a second quantity of the material is to be used in executing another order object from which part of the information was obtained, and wherein the cross-docking operation includes obtaining the second quantity from the first quantity without entering the second quantity into stock inventory.

15. A computer program product tangibly embodied in a machine-readable storage device and comprising instructions that when executed by a processor perform a method for providing status information for a material, the method comprising:
obtaining information from at least one electronic database order object that has been released from a planning process for execution, the order object defining a requirement for a material;
determining, using the obtained information, status information for the material for a location; and
generating a predefined output regarding the material using the determined status information.

16. A computer program product tangibly embodied in a machine-readable storage device, the computer program product including instructions that, when executed, generate on a display device a graphical user interface for providing status information for a material, the graphical user interface comprising:
a first input control for user identification of a material to cause information to be obtained from at least one electronic database order object that has been released from a planning process for execution, the order object defining a requirement for the material;
an area presenting information about a status of the material at a location, the information about the status determined using the obtained information; and
a second input control for a user to initiate, after presentation of the information about the status of the material, an action to modify the status.

17. The computer program product of claim 16, wherein the information about the status of the material specifies at least one of:
an amount of the material that is available at the location at a future time; and
an amount of time before a supply of the material at the location is depleted absent replenishment.

18. The computer program product of claim 16, wherein the action that can be initiated is a replenishment operation to supply an amount of the material.

19. The computer program product of claim 16, wherein the action that can be initiated is a cross-docking operation involving the material.

20. The computer program product of claim 16, wherein the action that can be initiated is a modification of an order regarding the material that is to be executed at the location.
